(19) United States
(12) Patent Application Publication
(10) Pub. No.: US 2002/0042285 A1
(43) Pub. Date: Apr. 11, 2002

(54) Portable device having removable front case

(76) Inventors: Toru Sakata, Fukuoka (JP); Masanori Settsu, Fukuoka (JP); Hiroshi Nishiyama, Fukuoka (JP); Atsushi Yamashita, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 09/962,331

(22) Filed: Sep. 26, 2001

(30) Foreign Application Priority Data
Sep. 26, 2000 (JP) 2000-292063

(51) Int. Cl. H04M 1/00

(52) U.S. Cl. 455/550; 455/90

(57) ABSTRACT

A portable device includes: a front case comprising, about an edge of its border, a protruding front case fixing claw, and a recess formed on an inner side of this claw; a battery lid contoured to fit externally to a lower case at its outer border edge; a middle case contoured to fit into the front case and comprising, about an edge of its border, a protruding middle case fixing claw engaging in the recess; and the lower case coupled to the middle case and comprising a hole. Both the claws pass through the hole. The lid urges the front case claw toward the middle case claw while fitting externally to the lower case. With this configuration, the front case does not come off in use or on external impact, and the front case fixing element is not exposed to the outside of the device, thus providing excellent design.

### FIELD OF THE INVENTION

The present invention relates to portable devices including radiotelephones such as cellular telephones and the like. More particularly, this invention relates to a portable device having a removable front case.

### BACKGROUND OF THE INVENTION

In a conventional radiotelephone having a removable front case, a fixing element (which forms a part of a fixing mechanism) of the front case is provided outside the device and is disengaged for removal of the front case from a body of the device. More specifically, removal of the front case from the body of the device takes place by disengaging the fixing element provided to the front case from a fixing element provided to either a middle case or a lower case.

This conventional type of radiotelephone is described hereinafter with reference to the accompanying drawings.

FIG. 3 is an external perspective view of a conventional radiotelephone having a detachable front case, and FIG. 4 is a cross section of the same radiotelephone.

In FIG. 3, front case 100 is secured to lower case 300 by front case fixing element 160 provided outside (on the outer wall of) the device.

In FIG. 4, middle case 200 has board 400, which is secured to lower case 300 by fixing screw 500. Front case 100 is contoured to cover middle case 200. At an edge of the border of this front case 100, front case fixing claw 110 is provided. This claw 110 is configured to fit into lower case 300 at an edge of the border of case 300 and has front case fixing claw projection 120 formed at the tip of claw 110. Corresponding to this projection 120, lower case fixing hole 310 is provided about an edge of the border of lower case 300.

In the device thus configured, front case 100 is secured to lower case 300 through engagement of projection 120 in hole 310. Removal of front case 100 takes place by deforming claw 110, whereby projection 120 can be disengaged from hole 310.

However, with the above-described conventional configuration, design of the device may be impaired because the fixing mechanism for fixing the front case is exposed to the outside of the device. In addition, there arise restrictions in shape and position on the front case fixing claw and the lower case fixing hole, and consequently, all these restrictions are difficult to materialize in the application of such a fixing mechanism to devices of various designs. Also, if the front case fixing claw is disengaged from the lower case fixing hole in use or on external impact, the front case comes off, so that a user must re-engage the claw in the hole.

### SUMMARY OF THE INVENTION

The present invention addresses the conventional problems discussed above and aims to provide a portable device configured not to cause a front case (a first case) to come off in use or on external impact, without impairment of design of the device.

The portable device of this invention includes the first case, and a fixing mechanism, provided in an internal part of the device that is covered with a second case, for fixing the first case to a body of the device.

With this configuration, the portable device of this invention does not have such an impaired design that a fixing element of the fixing mechanism is exposed to the outside of the device. This device is also applicable to various designs because the fixing mechanism is free of restrictions in shape and position. In addition, this portable device of the present invention does not suffer from a situation in which the first case comes off in use or on external impact. The portable device of this invention is applicable to, for example, radiotelephones including cellular telephones.

### BRIEF DESCRIPTION OF THE DRAWINGS

FIG. 1 is a perspective view of a radiotelephone in accordance with an exemplary embodiment of the present invention.

FIG. 2A is a top plan view of a principal part of the radiotelephone of Fig.

FIG. 2B is a cross section taken along line 2B-2B of FIG. 2A.

FIG. 2C is an enlarged sectional view of a principal part of FIG. 2B.

FIG. 3 is a perspective view of a conventional radiotelephone.

FIG. 4 is a cross section of the radiotelephone of FIG. 3.

### DESCRIPTION OF THE PREFERRED EMBODIMENT

A portable device of the present invention, for example, a radiotelephone is configured as follows.

The radiotelephone includes:(a) a replaceable front case; (b) a main case contoured to fit into the front case and having a built-in circuit board; and (c) a battery lid covering a housing which receives a battery. The battery lid covers a locking mechanism intended for locking the front case to the main case, while being urged against the locking mechanism at an edge of the outer border of the lid, thereby to limit the motion of this locking mechanism.

An exemplary embodiment of the present invention is concretely demonstrated hereinafter with reference to the accompanying drawings.

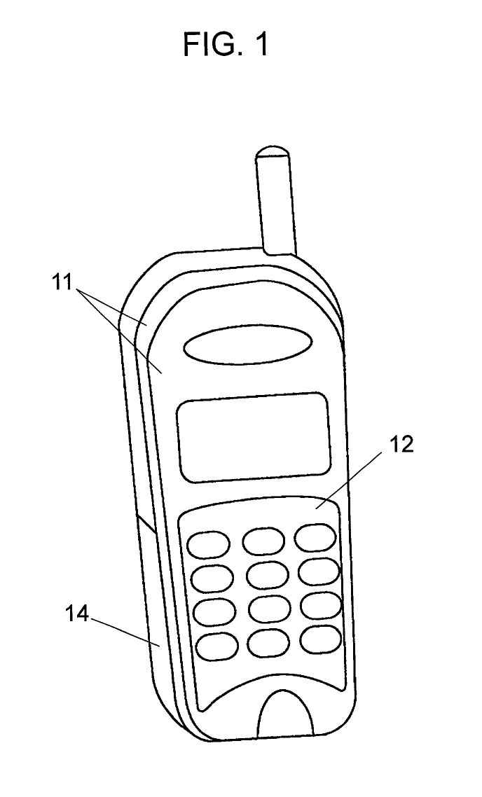

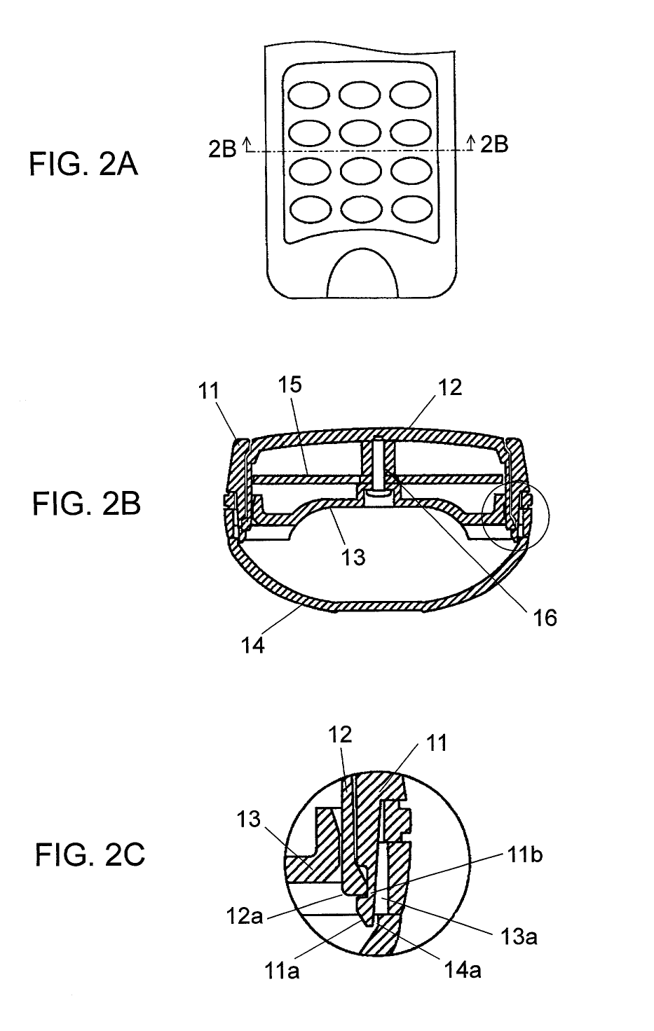

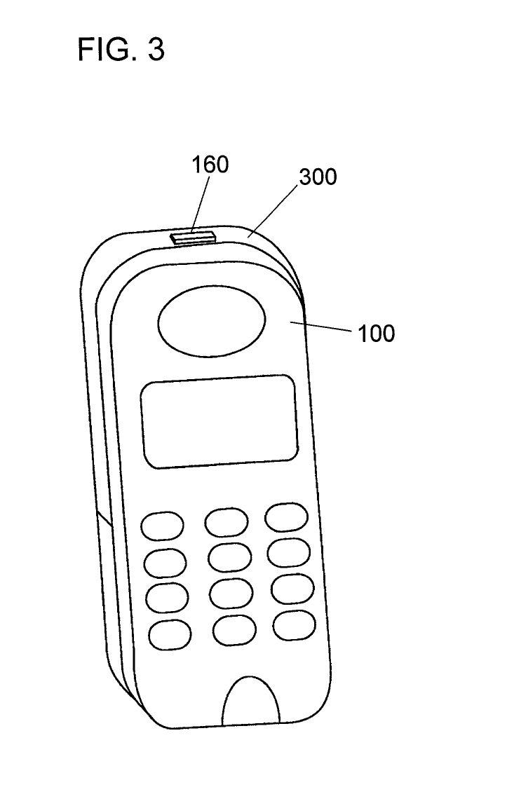

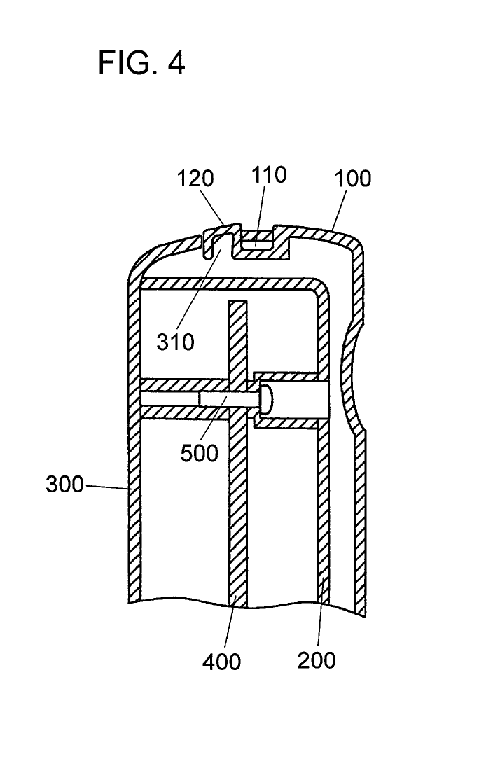

FIG. 1 is a perspective view of a radiotelephone in accordance with the exemplary embodiment of the present invention. FIG. 2A is a top plan view of a principal part of the radiotelephone of FIG. 1, and FIGS. 2B and 2C are a cross section taken along line 2B-2B of FIG. 2A and an enlarged sectional view of a principal part of FIG. 2B, respectively.

In FIGS. 1 and 2B, entire front case (first case) 11 is shaped like a frame. Battery lid (second case) 14 covers a housing formed at the back of a main case to receive a battery. This main case is comprised of middle case (third case) 12, and lower case (fourth case) 13 coupled to middle case 12 from under case 12. Middle case 12 is contoured to fit into front case 11, while battery lid 14 is contoured to fit externally to the main case (specifically, lower case 13) at an edge of the outer border of lid 14. Circuit board 15 is housed in the main case, which is formed by coupling lower case 13 to middle case 12. In other words, lower case 13 is secured to middle case 12 together with board 15 by fixing screw 16.

The following configuration forms a locking mechanism intended for locking front case 11 to the main case. As shown in FIG. 2C, front case 11 has front case fixing claws (first projections) 11a that protrude about an edge of the border of case 11 and are positioned symmetrically on respective sides of case 11. These claws 11a have front case fixing claw recesses (locking parts) 11b formed on respective inner sides of claws 11a. Middle case 12 has middle case fixing claws (second projections) 12a that protrude about an edge of the border of case 12, engage in respective recesses 11b and are positioned symmetrically on respective sides of case 12. Lower case 13 has lower case holes 13a corresponding to respective front case claws 11a and respective middle case claws 12a to each allow claws 11a and 12a to pass through.

Battery lid 14 has, in its inner surface (inner wall), symmetrical battery lid recessed parts 14a urging corresponding front case claws 11a toward respective middle case claws 12a with lid 14 being fit externally to the main case (specifically, lower case 13).

In the above-described configuration, when front case 11 is mounted to middle case 12 from above, each front case claw 11a passes through corresponding lower case hole 13a, and each middle case claw 12a engages in corresponding recess 11b formed on the inner side of claw 11a. Consequently, front case 11 is secured to the main case, i.e. comprised of middle case 12 and lower case 13.

With battery lid 14 being mounted to the main case, each recessed part 14a in the inner surface (inner wall) of lid 14 urges corresponding front case claw 11a toward middle case claw 12a. Thus, each front case claw 11a becomes incapable of moving in the direction of disengagement between front case recess 11b and middle case claw 12a while battery lid 14 is being mounted. Consequently, front case 11 is prevented from coming off a body of the device. In addition, even if the device receives an impact when dropped for example, front case 11 does not come off.

Removal of front case 11 takes place by detaching battery lid 14 from the body of the device and deforming each front case claw 11a outward, that is, in the direction of disengagement between corresponding recess 11b and claw 12a, whereby each claw 12a is disengaged from corresponding recess 11b.

According to the above-described configuration, the front case fixing claws, the front case claw recesses and the middle case fixing claws are covered with the battery lid, so that they are prevented from being disengaged by touch. In addition, the battery lid ensures their engagement by urging each of the front case fixing claws in the direction of the engagement between the corresponding middle case fixing claw and the corresponding front case claw recess, so that the front case hardly comes off the body of the device. Consequently, there can be obtained an advantage that the front case does not come off in use or on external impact.

As is clear from the above description, according to the present invention, the fixing element of the front case is not provided outside, but inside the device, and the battery lid, which is one of the components of the present device, disenables the disengagement of the front case fixing element. With this configuration, the device does not have such an impaired design that the front case fixing element, as is conventionally seen, is exposed to the outside of the device. The device thus configured is also applicable to various designs because the front case fixing claw and the lower case hole are both free of restrictions in shape and position. In addition, there can be obtained an advantage that the front case does not come off in use or on external impact.

What is claimed is:

1. A portable device comprising:
a first case; and
a fixing mechanism, disposed in an internal part of the device, for fixing said first case to a body of the device, said internal part being covered with a second case.

2. The portable device of claim 1, wherein said second case is urged against said fixing mechanism to prevent removal of said first case from said body of the device.

3. The portable device of claim 1, wherein said first case is a front case, said second case is a battery lid, and said fixing mechanism includes a locking mechanism for locking said front case to said body of the device.

4. The portable device of claim 2, wherein said first case is a front case, said second case is a battery lid, and said fixing mechanism includes a locking mechanism for locking said front case to said body of the device.

5. A portable device comprising:
(a) a first case comprising a first projection and a locking part;
(b) a second case;
(c) a third case comprising a second projection locked by said locking part, said third case being contoured to fit into said first case; and
(d) a fourth case coupled to said third case,
wherein said second case fits externally to said fourth case at an edge of an outer border of said second case, said fourth case comprises a hole through which said first and second projections pass, and said second case urges said first projection toward said second projection while fitting externally to said fourth case.

6. The portable device of claim 5, wherein said first case is a front case, said second case is a battery lid, said third case is a middle case, and said fourth case is a lower case.

7. A portable device comprising:
(a) a front case comprising a front case fixing claw protruding about an edge of a border of said front case, and a front case fixing claw recess formed on an inner side of said front case fixing claw;
(b) a battery lid;
(c) a middle case fitting into said front case, said middle case comprising a middle case fixing claw protruding about an edge of a border of said middle case, said middle case fixing claw engaging in said front case fixing claw recess; and
(d) a lower case coupled to said middle case,
wherein said battery lid fits externally to said lower case at an edge of an outer border of said battery lid, said lower case comprises a hole through which said front case fixing claw and said middle case fixing claw pass, and said battery lid urges said front case fixing claw toward said middle case fixing claw while fitting externally to said lower case.

8. A radiotelephone comprising:
(a) a replaceable front case;
(b) a main case contoured to fit into said front case, said main case having a built-in circuit board; and
(c) a battery lid covering a housing for receiving a battery,
wherein said battery lid covers a locking mechanism for locking said front case to said main case and is urged against said locking mechanism at an edge of an outer border of said battery lid for limiting the motion of said locking mechanism.

9. The radiotelephone of claim 8, wherein said main case is formed by coupling a lower case to a middle case.

10. A radiotelephone comprising:
(a) a frame-like front case;
(b) a middle case contoured to fit into said front case;
(c) a lower case coupled to said middle case; and
(d) a battery lid covering a housing for receiving a battery, said battery lid being contoured to fit externally to said lower case at an edge of an outer border of said battery lid,
wherein said front case comprises a front case fixing claw protruding about an edge of a border of said front case, said front case fixing claw has a front case fixing claw recess formed on an inner side of said front case fixing claw, said middle case comprises a middle case fixing claw protruding about an edge of a border of said middle case and engaging in said front case fixing claw recess, said lower case comprises a lower case hole through which said front case fixing claw and said middle case fixing claw pass, and said battery lid has an internal surface urging said front case fixing claw toward said middle case fixing claw with said battery lid being fit externally to said lower case.

11. A radiotelephone comprising:
(a) a frame-like front case;
(b) a middle case contoured to fit into said front case;
(c) a lower case comprising a lower case hole, said lower case being coupled to said middle case from under said middle case; and
(d) a battery lid contoured to fit externally to said lower case at an edge of an outer border of said battery lid,
wherein said lower case is fixed to said middle case together with a circuit board by a fixing screw, said front case comprises a front case fixing claw protruding about an edge of a border of said front case, said front case fixing claw has a front case fixing claw recess formed on an inner side of said front case fixing claw, said middle case comprises a middle case fixing claw protruding about an edge of a border of said middle case and engaging in said front case fixing claw recess, said front case fixing claw passes through said lower case hole and brings said middle case fixing claw into engagement in said front case fixing claw recess when said front case is mounted to said middle case from above, and said battery lid comprises, in an inner surface of said battery lid, a battery lid recessed part urging said front case fixing claw toward said middle case fixing claw with said battery lid being fit externally to said lower case.
